(19) United States
(12) Patent Application Publication
(10) Pub. No.: US 2024/0000263 A1
(43) Pub. Date: Jan. 4, 2024

(54) AUTONOMOUS COOKING GRILL

(71) Applicant: GASTRONOMOUS TECHNOLOGIES INC., Oakville (CA)

(72) Inventors: Kevork SEVADJIAN, Oakville (CA); Andrew SKREPNEK, Burlington (CA); Kristian TAZBAZIAN, Oakville (CA)

(21) Appl. No.: 17/810,137

(22) Filed: Jun. 30, 2022

(30) Foreign Application Priority Data
Jun. 29, 2022 (CA) 3,166,189

(51) Int. Cl. A47J 37/04; A47J 37/06; B25J 9/16; B25J 9/00

(52) U.S. Cl. CPC A47J 37/044; A47J 37/0682; A47J 2202/00; B25J 9/0087; B25J 9/1682

(57) ABSTRACT

The autonomous cooking grill comprises a grate or griddle connected to a rotatable hub which is connected to a hub rotating means, all supported by a grill body, wherein when the hub rotating means is activated the hub rotates the grate. In a further embodiment, the autonomous cooking grill comprises a griddle connected to a rotatable hub which is connected to a hub rotating means, all supported by a grill body, wherein when the hub rotating means is activated the hub rotates the griddle. The autonomous cooking grill can have one or more of the additional features of autonomous flipper(s), autonomous ejector(s), autonomous grate cleaner(s) and autonomous temperature probe(s), and bins to store cooked food products ejected from the grill. The features are utilized with suitable food products, such as patties. The autonomous cooking grill can use gas (or alternatively electricity) for cooking and use an electric actuator to turn the grate or griddle. The autonomous cooking grill may additionally comprise a cover to partially cover the grill or griddle. In a further embodiment, there is additionally a center grill for manually cooking food.

### FIELD OF THE INVENTION

The present invention relates to a cooking grill, and more specifically to a cooking grill for autonomously cooking food.

### BACKGROUND OF THE INVENTION

Standalone cooking grills for restaurant kitchens are typically gas-powered or electric-powered, stainless steel or similar material, in a square or rectangular shape, with a grate of a corresponding shape. Such grills may be used for cooking various foods. Drawbacks to using such indoor grills include: human error, inattention, and inconsistencies; non-uniform heating; and heat loss. Inventors have tried to address these issues, for example, in U.S. Pat. No. 10,441,108 dated October 2019, which is for a portable smokeless charcoal charbroiler; U.S. Pat. No. 8,272,320 dated Sep. 25, 2012, which is for a cooking grill with waste heat recovery; and U.S. Pat. No. 6,079,320 dated Jun. 27, 2000, which is for a broiler with even heat distribution.

However, these grills require a person to flip a burger, measure the temperature for safety, and clean the grill. U.S. Pat. No. 9,788,687 dated Oct. 17, 2017, describes a system for cooking a burger without requiring a person to flip the burgers, which has individual upper plate and lower plate for each patty and conveyors for moving the patties. This takes up more room than a typical grill due to the conveyancing systems and does not provide for flipping patties on a grill with the desirable grill marks on the cooked patties.

A robotic assistant for preparing food is described in U.S. patent application Ser. No. 16/490,534 published Apr. 23, 2020, under Pub. No. US2020/0121125. This application claims that the robotic assistant can flip a burger, uses sensors to identify objects, and also uses whatever equipment is in the kitchen. A grill “manned” by a robotic assistant must be programmed to work with the existing equipment. The processor is operable to command the robotic arm to perform a food preparation step on the food items in the kitchen workspace based on order information, recipe information, kitchen equipment information, and camera data. In embodiments, the robotic kitchen assistant has detailed information on some or all of the restaurant's recipes and is integrated with the restaurant's point of sale (POS) computer system and receives all restaurant orders. In further embodiments, the robotic kitchen assistant is also integrated with the restaurant's kitchen display system (KDS) and uses that system along with its own human interface to communicate information and instructions to the human kitchen worker. In further embodiments, the robotic kitchen assistant uses temperature information data and information on when batches of cooked fries were completed, incoming orders, historical demand, and/or visual analysis of the prepared fries in the receiving bin (including amount remaining), to determine when to prepare additional fries. In further embodiments, the robotic kitchen assistant automatically maintains an inventory of other food items.

In U.S. patent application Ser. No. 16/635,171, published May 21, 2020 under Pub. No. 2020/0154948, there is described an identification unit for identifying the selected given food. The control system adapted to manage the food processing unit and the collecting element to thereby prepare food according to a selected recipe. According to an embodiment, the system further comprises at least one load cell for measuring a corresponding weight of an ingredient. According to a further embodiment, the control system is operated via a user interface, and the user interface is selected from a group comprising at least one of a touchscreen, a voice recognition software, an application platform and a keyboard. The control system may be operated by a user via a wireless connection.

Other apparatus is available for autonomizing kitchen work, including robotic arms of various manufacturers including FANUC™ Corporation of Japan which includes multiple electric motors to provide motion and UR5e™ of Universal Robots

What is needed is a compact grill which autonomously cooks food safely, reliably, and efficiently.

### SUMMARY OF THE INVENTION

In an embodiment of the present invention there is an autonomous cooking grill comprising a grate connected to a rotatable hub which is connected to a hub rotating means, all supported by a grill body, and wherein when the hub rotating means is activated the hub rotates the grate.

The autonomous cooking grill additionally comprises one or more of the features of at least one autonomous flipper, at least one autonomous ejector, at least one autonomous grate cleaner and at least one autonomous temperature probe.

The autonomous cooking grill can comprise two autonomous flippers, or two autonomous ejectors or two autonomous flippers and two autonomous ejectors

The autonomous cooking grill can comprise at least one gas burner to heat the grate.

The hub rotating means can be comprised of an electric actuator and an actuator connecting means, wherein the actuator connecting means connects the hub to the actuator.

The grate may comprise a supporting frame and grate segments wherein the supporting frame is attached to the hub and the grate segments rest on the supporting frame.

In a further embodiment of the present invention, there is an autonomous cooking grill comprising a griddle connected to a rotatable hub which is connected to a hub rotating means, all supported by a grill body, wherein when the hub rotating means is activated the hub rotates the griddle.

This autonomous cooking grill with a griddle may additionally comprise at least one autonomous flipper and at least one autonomous grate cleaner.

Alternatively, this autonomous cooking grill with a griddle may additionally comprise at least one autonomous flipper, at least one autonomous ejector, and at least one autonomous grate cleaner.

These autonomous cooking grills with a griddle may additionally comprise an autonomous temperature probe.

In a further embodiment of the present invention there is an autonomous cooking grill comprising a grate or griddle connected to a rotatable hub which is connected to a hub rotating means, all supported by a grill body, and wherein when the hub rotating means is activated the hub rotates the grate, which additionally comprises a robot arm capable of performing one or more of the functions of food flipping, food ejecting, food removing, food temperature measuring, and grate or griddle cleaning.

In a further embodiment of the present invention there is an autonomous cooking grill comprising a rotatable grate or griddle connected to a rotating means, comprising at least one autonomous tool.

The at least one autonomous tool is a flipper. Or the at least one autonomous tool are a flipper and an ejector. Or the at least one autonomous tool are a flipper and a grill cleaner. Or the at least one autonomous tool are a flipper and an ejector and a grill cleaner and a temperature probe. Or the at least one autonomous tool is one tool capable of flipping, ejecting, and cleaning. Or the at least one autonomous tool is one tool capable of flipping, temperature probing, ejecting, and cleaning. Or the at least one autonomous tool is one tool capable of flipping and ejecting. Or the at least one autonomous tool are a first tool capable of flipping and ejecting and a second tool capable of cleaning. Or the at least one autonomous tool are a first tool capable of flipping and a second tool capable of ejecting and cleaning.

In a further embodiment of the present invention there is an autonomous cooking grill comprising a rotatable grate or griddle connected to a rotating means, comprising at least one autonomous tool and a processing unit configured to control the at least one autonomous tool.

In a further embodiment of the present invention there is an autonomous cooking grill comprising a rotatable grate or griddle connected to a rotating means, comprising at least one autonomous tool and a partial cover for covering part of the grate or griddle.

In a further embodiment of the present invention there is an autonomous cooking grill comprising a rotatable grate or griddle connected to a rotating means, comprising at least one autonomous tool and a rotatable or non-rotatable center grill for manually cooking food.

### BRIEF DESCRIPTION OF THE FIGURES

These and other aspects of the present invention will be apparent from the brief description of the drawings and the following detailed description in which:

FIG. 1 is a perspective view of an autonomous cooking grill of an embodiment of the present invention.

FIG. 2 is a top view of the cooking grill of FIG. 1.

FIG. 3 is a front view of the cooking grill of FIG. 1.

FIG. 4 is a left side view of the cooking grill of FIG. 1.

FIG. 5a is a perspective view of a grill body of a cooking grill of an embodiment of the present invention.

FIG. 5b is a top view of the grill body of FIG. 5a.

FIG. 5c is a front view of the grill body of FIG. 5a.

FIG. 5d is a left side view of the grill body of FIG. 5a.

FIG. 6 is an exploded view of the cooking grill of FIG. 1

FIG. 7 is a perspective view of a heating system of a cooking grill of an embodiment of the present invention.

FIG. 8 is a perspective exploded view of a grate system of a cooking grill of an embodiment of the present invention.

FIG. 9a is a perspective view of a flipping system of a cooking grill of an embodiment of the present invention.

FIG. 9b is an exploded perspective view of a flipping system of FIG. 9a.

FIG. 10a is a perspective view of an extended ejector system of a cooking grill of an embodiment of the present invention.

FIG. 10b is an exploded perspective view of an extended ejector system of FIG. 10a.

FIG. 11a is an exploded perspective view of a cleaner system of a cooking grill of an embodiment of the present invention.

FIG. 11b is a perspective view of a cleaner system of a cooking grill of FIG. 11a in idle position.

FIG. 12a is a perspective view of a temperature probe system of a cooking grill of an embodiment of the present invention in sanitizing position.

FIG. 12b is a perspective view of a temperature probe system of FIG. 12a in idle position.

FIG. 12c is a perspective view of a temperature probe system of FIG. 12a in probing position.

FIG. 13 is a perspective view of an autonomous cooking grill of a further embodiment of the present invention.

FIG. 14 is a perspective view of the top of an autonomous cooking grill of a further embodiment of the present invention.

FIG. 15 is a top view of the autonomous cooking grill of FIG. 14 with modifications.

### DETAILED DESCRIPTION OF THE INVENTION

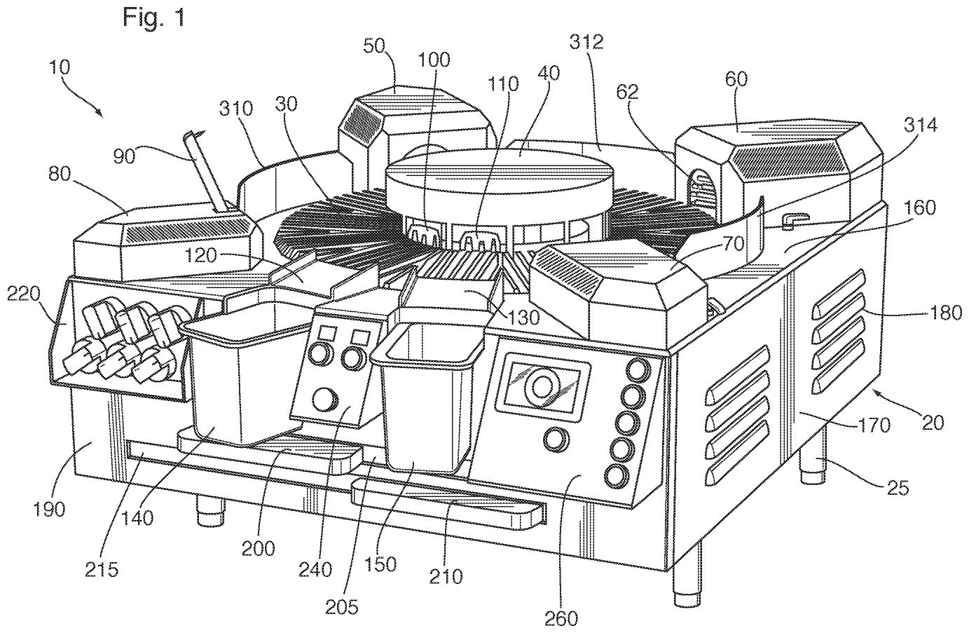

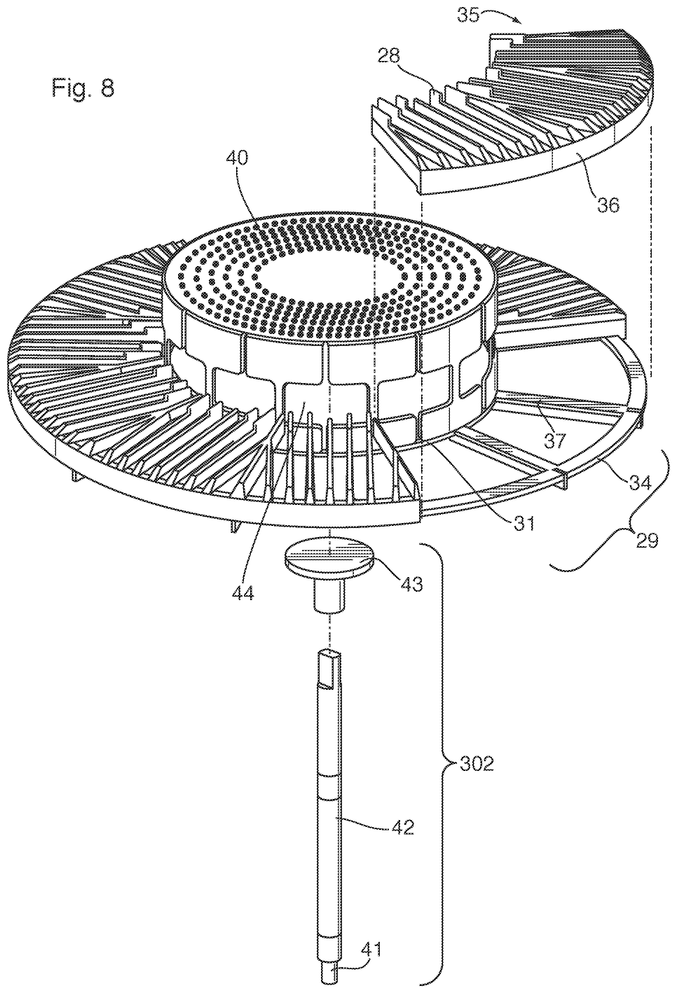

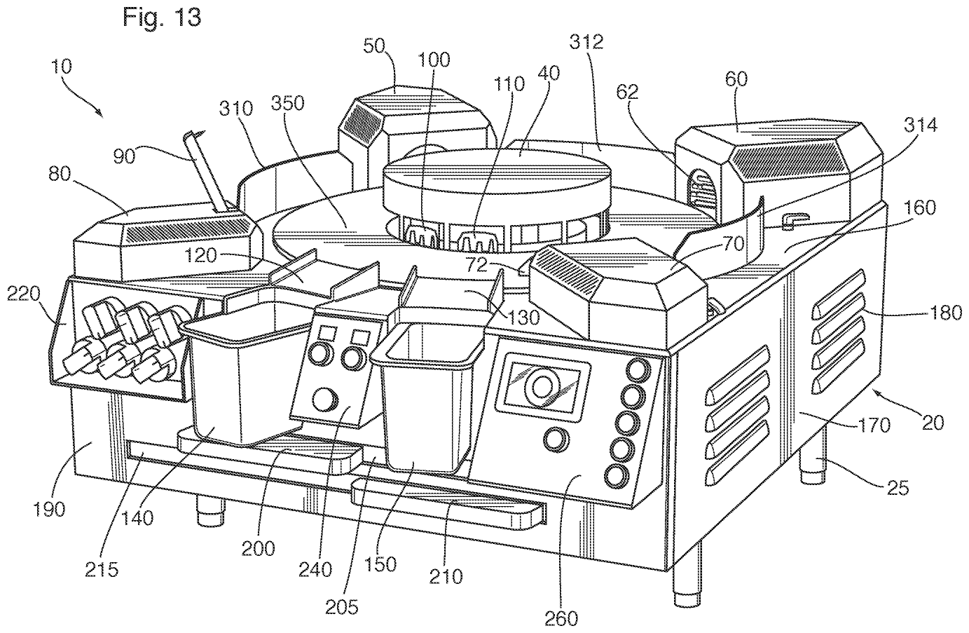

As shown in FIG. 1, the autonomous cooking grill 10 of the present invention comprises a grate (or griddle 350, shown as a solid metal sheet in FIG. 13) in the center, a rotatable hub 40, and a hub rotating means 39 (shown in FIG. 8), all supported by a grill body 20, in which the grate (or griddle 350) is supported by a frame 29 connected to the hub 40, the hub rotating means 39 (not shown) is connected to the hub 40, and wherein when the hub rotating means 39 is activated the hub 40 rotates the grate 30 (or griddle 350). In an alternative embodiment the grate or griddle may be rotated by an external gear system.

The autonomous cooking grill 10 can have one or more of the additional tool features of autonomous flipper(s) 62, autonomous ejector(s) 100, 110, autonomous grate cleaner 72, and autonomous temperature probe 90. With these flipping and effecting features, the autonomous cooking grill 10 of the present invention grills suitable food products, autonomously flips the food product and ejects the food product off the grill. In further embodiments, the autonomous cooking grill additionally autonomously cleans the grate 30 (or griddle 350) and measures food product temperature, or has various combinations of the above features. In an embodiment to the present invention, these tool features can be combined into one tool. The autonomous cooking grill 10 can use gas for cooking and use an electric actuator (not shown) to turn the grate.

In an embodiment of the present invention as seen in FIGS. 1 to 4 and 6, there is an autonomous cooking grill 10 comprising a rotating grate 30 in a grill body 20. On the outside periphery of the grate 30 is a first flipper housing 60 and a second flipper housing 50, each of which house a flipper 62. Alternatively, there could be one flipper 62 with a tool changer capability e.g. from a meat flipper to a veggie flipper. In the embodiment of the invention shown in the figures there is also a grill cleaner housing 70, which houses a grill cleaner 72, and a temperature probe housing 80 having a temperature probe 90 with a thermometer 92. In an alternative embodiment, one or more of the flipper(s) 62, grill cleaner 72 and temperature probe 90 may be located in the center of the grate 30 or griddle 350, or above on a gantry style system.

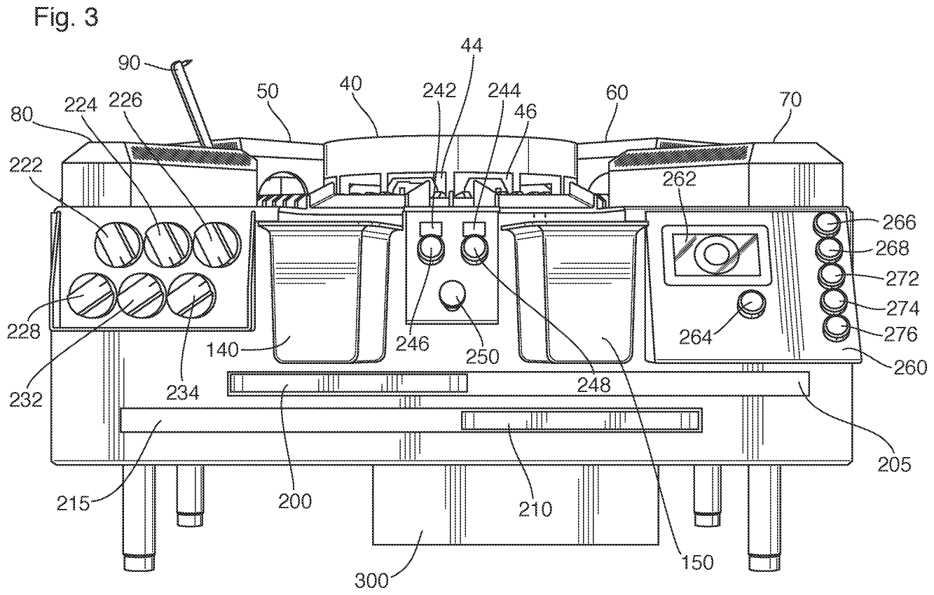

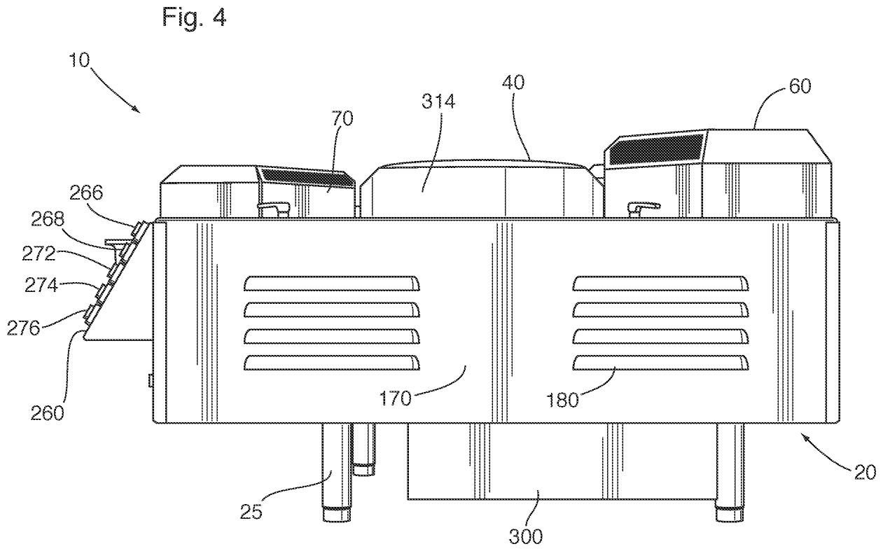

As seen in FIGS. 3 and 4, the grill body 20 rests on legs 25 which raise it high enough to accommodate an actuator (not shown) within the actuator cover 300 underneath the grill body 20.

In the hub 40 there are ejector openings 44 through one of which can be seen a first ejector face 100 and through another ejector opening 44 can be seen a second ejector face 110. Across from the first ejector face 100 is a first ejector ramp 120 which ends in a first bin 140. Across from the second ejector face 110 is a second ejector ramp 130 which ends in a second bin 150. The ejector faces 100, 110 are identical in this embodiment, but could be differentiated for different food products.

In an alternative embodiment, instead of the ejector(s) described above, one or more further flippers 62 may be used which lift and drop food into the bin 140, 150 rather than push it in. In a further alternative embodiment, instead of the ejector(s) described above, the flipper 62 which flips the food also acts as an ejector by scooping up the food but, instead of flipping it, drop it in a bin 140, 150. As such, the flipper 62 which also acts to “eject” the food into a bin may be placed closer to the bins or the bins moved closer to the flipper 62. In yet another embodiment, with a tool changer one mechanism can flip, eject, temperature probe and clean.

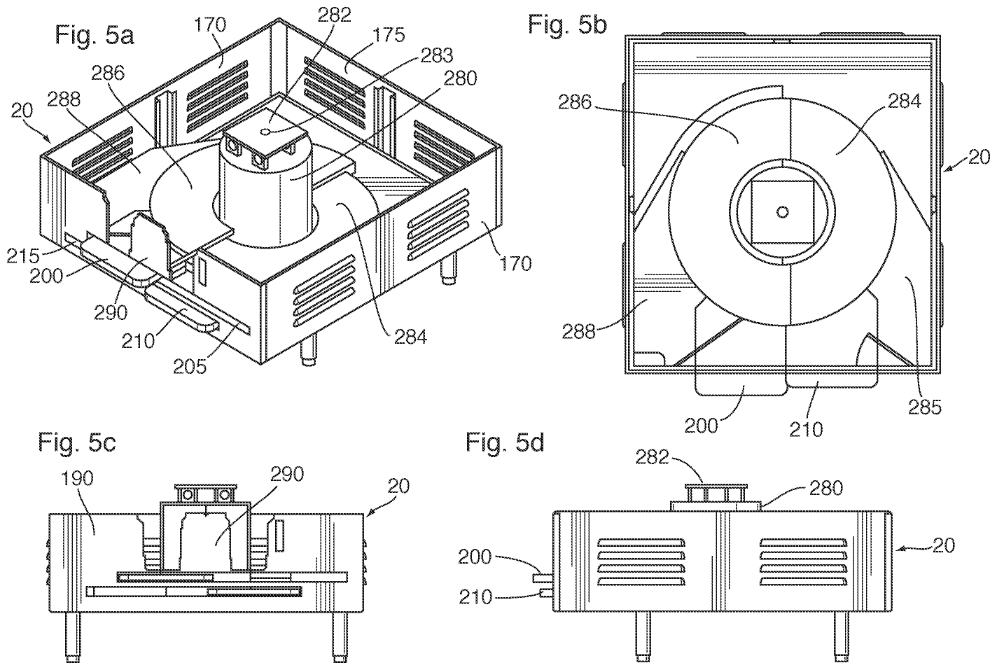

In the embodiment, as shown in FIGS. 5a to 5d, the grill body 20 has a grill body top 160 (see FIG. 1), grill body sides 170, grill body back 175 and grill body front 190. The grill body sides 170 and grill body back 175 have grill body vents 180. At the front of the grill body 20 there can be seen a first drip tray handle 200 and second drip tray handle 210 extending out from first drip tray slot 205 and second drip tray slot 215, respectively. In another embodiment of the invention there are four drip trays. It will be understood that the drip trays are for managing food product drippings which are a result of any food grilling and other means of collecting drippings and food debris may be utilized.

At the front of the cooking grill 10 shown in the embodiment shown in FIGS. 1 to 3, there is a gas knobs panel 220, an ejector system panel 240 and a main user panel 260. As shown in FIG. 3, the ejector system panel has a first ejector counter 242, a second ejector counter 244, a first ejector reset button 246, a second ejector reset button 248 and an emergency stop button 250. The ejector system is optional since it is not necessary to count how many times food is ejected from the system, and alternatively this information can be collected with load and/or visual sensors and data collected remotely. The main user panel 260 has a main user display 262, temperature probe maintenance button 264, as well as first to fifth food product selection buttons 266, 268, 272, 274, 276. The main user panel 260 may be on a stand for the grill or flip screen on the grill. As will be understood, the above components can be in different locations, can be in different configurations, can be operated by touch screen, can be operated on a remote or accessible with an App or computer program. With vision and or load sensors, button controls may be eliminated. Data may be collected for quality control purposes and/or for improving the cooking process. A touch-screen may be detachably coupled to the front, top or side of the autonomous cooking grill 10.

FIGS. 5a to 5d show the grill body 20 of a cooking grill of an embodiment of the present invention. To cover the ejectors 99 (not shown) there is an ejector plate 282, with an ejector plate opening 283, attached to the top of an ejector stand 280. The first drip tray 284 and second drip tray 286 rest on a first drip tray support shelf 285 and a second drip tray support shelf 288, respectively. The grill body front 190 has a middle grill body front segment 290 between the bins 140, 150.

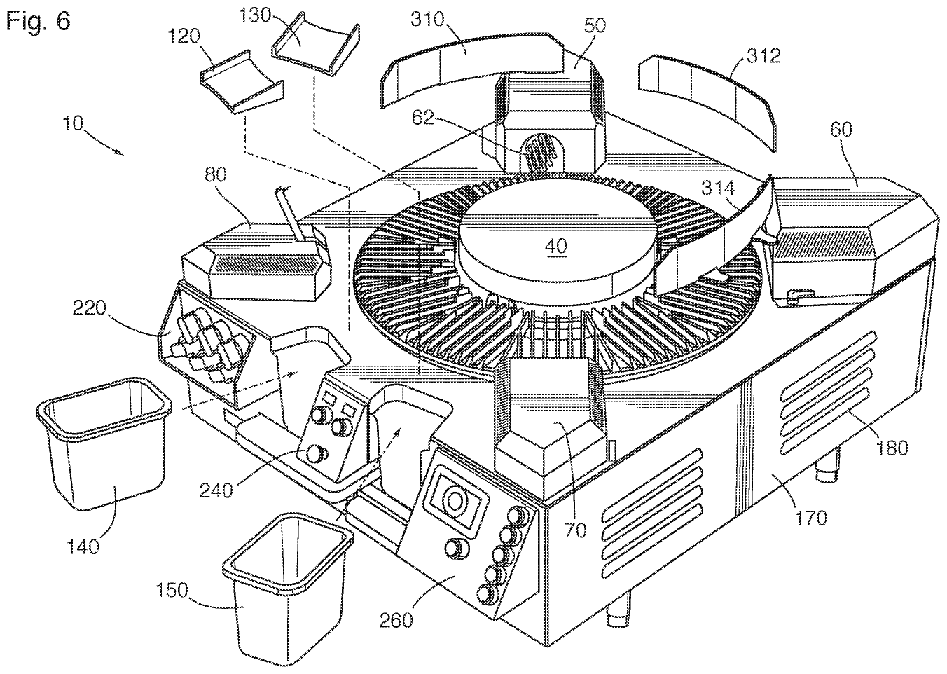

FIG. 6 shows the parts of the cooking grill of FIGS. 1 to 4 in exploded view to show the first grill guard 310, second grill guard 312 and third grill guard 314 which provide an optional back up to catch any food from sliding off the grate 30 and capture some grease splatters.

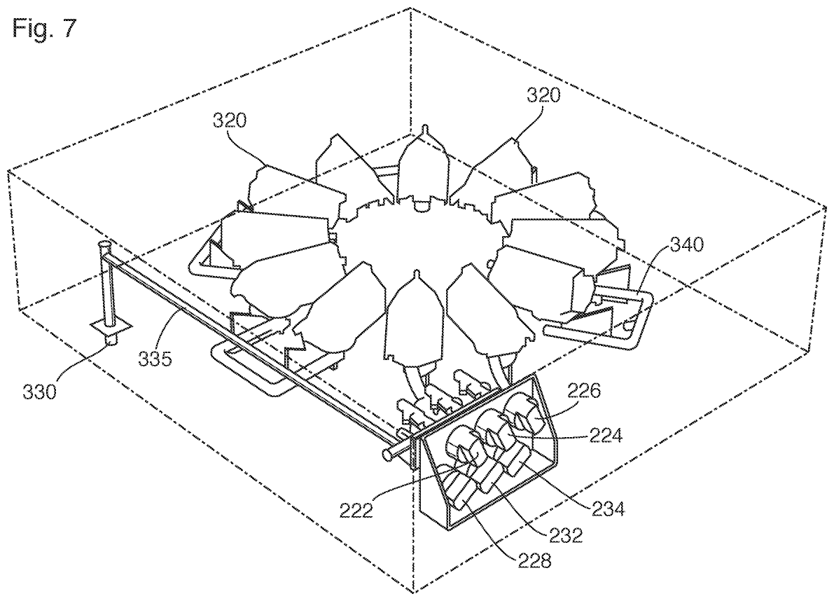

FIG. 7 shows the heating system of a cooking grill of an embodiment of the present invention. The gas burners 320 are supplied with gas that enters via a gas inlet 330, through gas inlet piping 335 and thereafter if one of gas knobs 222, 224, 226, 228, 232, 234, is opened to the respective burner's gas piping 340. It will be understood that there may be one gas burner or multiple gas burners, as well as one or multiple controls for the gas burners or autonomously regulated heating from gas burner(s). Additionally, there may be one or more deflector or radiant to distribute the heat, made from a variety of materials, such as, cast iron, stainless steel, or ceramic etc.

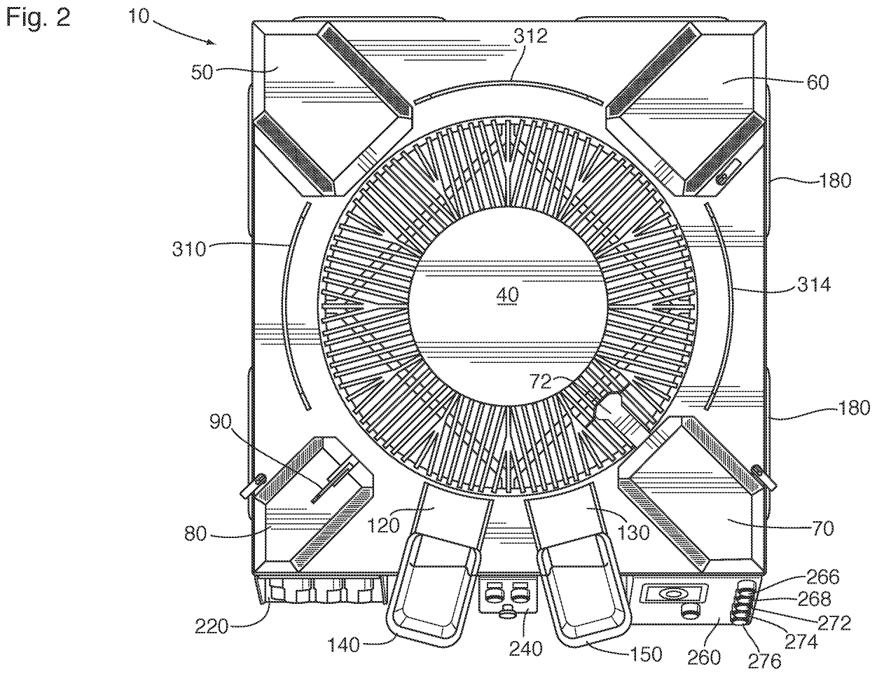

FIG. 8 shows a grate system of a cooking grill of an embodiment of the present invention. The grate 30 is comprised of grate segments 35 which rest on a supporting frame 29 comprised of a frame inner ring 31 and frame outer ring 34 with frame spokes 37 in between. (The frame 29 could also be tubular with corresponding shaping of the grate 30 to securely rest on the frame). The outer edge of each grate segment 35 forms a grate lip 36 which rests over the frame outer ring 34. The frame inner ring 31 is attached to the hub 40. The grate may be comprised of grate segments 35 on a frame 29, since cleaning is easier with grate segments 35, or a one-piece grate or griddle that can still be removable for cleaning. The grate 35 (or griddle 350) and supporting frame 29 could also be contiguous, and still be removably attached to the hub 40 to enable it to be removed for cleaning. FIG. 2 shows the outline of an embodiment of an alternative frame to support the grate 30.

A hub rotating means 39 is comprised of a hub attachment means 43, an axle 42, and an actuator connector means 41. The axle 42 is attached at a first end to the hub attachment means 43 which is secured under the center of the hub 40. The axle 42 is connected at a second end to the actuator connector means 41 which is attached to an actuator (not shown) within the actuator cover 300. It will be understood that in the present invention movements are affected by a respective actuator and that mechanisms may be driven by available modes such as, pneumatic, hydraulic, belt-driven, leadscrew, ballscrew. For examples, there could be two actuators per flipper 62 (one to rotate and one to extend), one actuator for the grill cleaner 72, one actuator for the temperature probe 90, one actuator to rotate the axle 42, three actuators for a flipper ejector (one each to extend, rotate and turn)

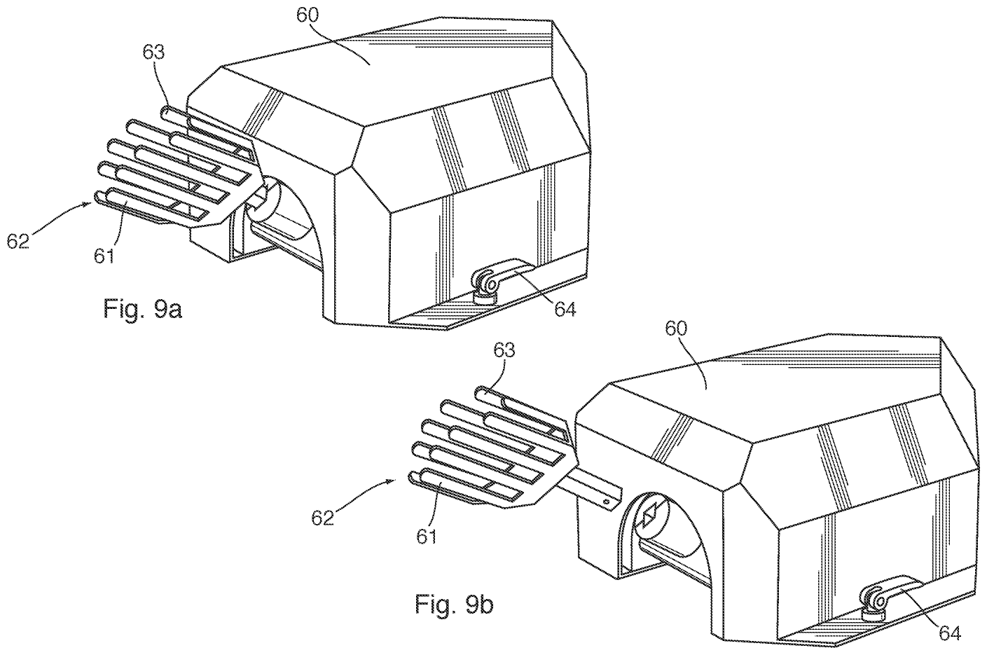

FIGS. 9a and 9b show an autonomous flipper 62 of a cooking grill of an embodiment of the present invention, which in this example is covered by a first flipper housing 60, and the second flipper housing 50 can be identical, with the only difference being the placement around the grate 30. The flipping system comprises the first flipper housing 60 which houses the flipper 62. The housing can be removed with the quick release handle 64. In this embodiment such handles 64 are found on each of the first flipper housing 60, second flipper housing 50, grill cleaner housing and temperature probe housing 80. It will be understood that other means for securing the housings may be used.

When a flipper 62 is activated, it emerges from the flipper housing 50, 60 and the flipper's lower prongs 61 slide just below the top of the grate slats 28 (see FIG. 8) and upper prongs 63 slide in above a food product. The flipper carriage is attached to a leadscrew which is driven by a motor.

When the motor actuates, it turns the leadscrew which pushes the flipper forwards. The leadscrew carriage is attached to a CAM which provides the direction for which the flipper moves. The flipper 62 then raises up to lift the food product held between the upper prongs 63 and lower prongs 61. There is another motor connected behind the coupling of the flipper attachment and flipping carriage. When the flipper wants to turn, this motor turns on. The flipper 62 twirls 180 degrees and lowers the food product back onto the grate slats 28 (reversing the upper and lower prongs to lower and upper prongs), after which the flipper 62 twirls back 180 degrees and retreats back into the housing 50, 60. In this embodiment, the flipper 62 slides out of the housing 50, 50 by a leadscrew powered by an electric actuator and travels on a cam which raises the flipper 62 off the grill and a second actuator rotates the flipper 180 degrees and retracts it back on the cam to a home position. With the embodiment of the present invention having a griddle 350, the lower prongs 61 slide along the griddle 350.

Ejectors 99 push, pull, or flip food off the grate 30 or griddle 350, and in an embodiment of the invention the ejectors 99 (not shown in the figures) has the same configuration and action as the flipper 62 described above. In a further embodiment the flipper 62 may also serve as an ejector rather than having a separate ejector (which may necessitate moving the flipper 62 close to the bins.

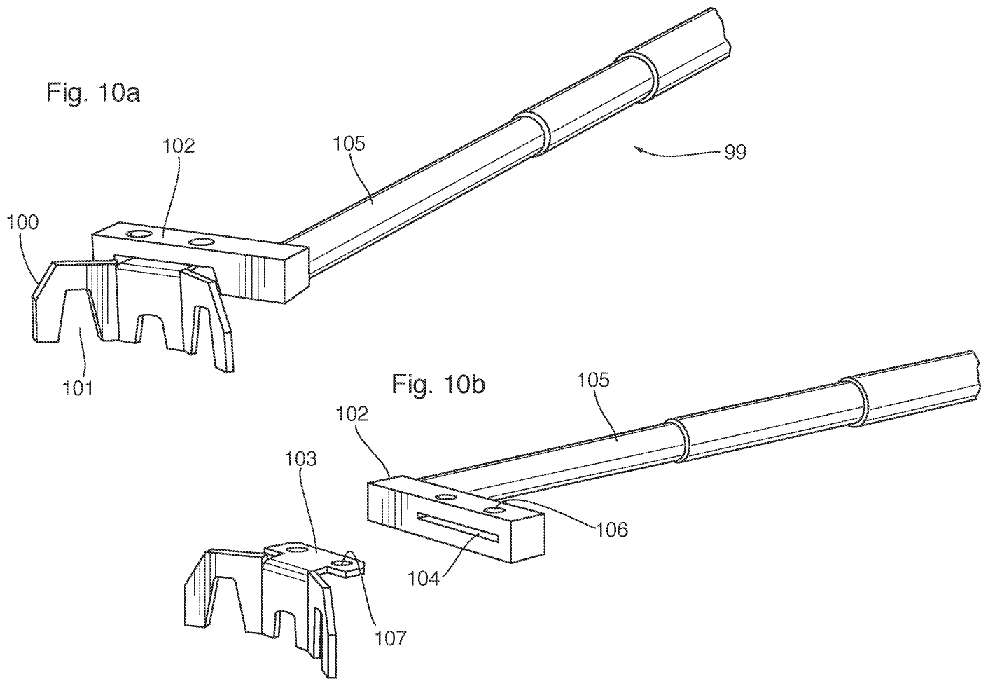

In an embodiment of the present invention with separate ejectors 99, FIGS. 10a and 10b show an autonomous ejector 99 of a cooking grill, which in this figure is described as having a first ejector face 100, but the ejector with the second ejector face 110 can be identical, and the only difference is the placement around the hub 40, and a different ejector face if desired. The ejector face 100 is extended by the ejector extending arm 105. The ejector extending arm 105 has an ejector arm attachment means 102 with a slot in ejector arm attachment means 104 to attach an ejector face 100. The ejector face 100, 110 has an ejector face attachment means 103 that fits into the slot 104 in the ejector arm attachment means 102 which is attached to the end of the ejector extending arm 105. The ejector face attachment means 103 can be secured into the slot 104 through fasteners or magnetically (not shown) through the corresponding arm attachment holes 106 and face attachment holes 107. The ejectors 99 are located under the ejector plate 282 (shown in FIGS. 5a to d) and an ejector 99 is on either side of the axle 42 which comes up through the ejector plate opening 283.

When an ejector 99 is activated, the telescoped ejector extending arm 105 extends to push an ejector face 100, 110 against a food product and push the food product off the grate 30 or griddle 350. The ejector face grooves 101 fit over the grate slats 28 to enable the ejector face to scrape a food product off the grate 30. For a griddle 350, the ejector face 100, 110 is raised to scrape the food product off the griddle and the ejector face 100, 110 may be a flat face rather than with ejector face grooves 101. The telescoping action of the ejector 99 is driven by a cable and pulley system underneath the grill powered by an electric actuator. As will be understood the ejectors may be configured differently including not having a telescoping aspect.

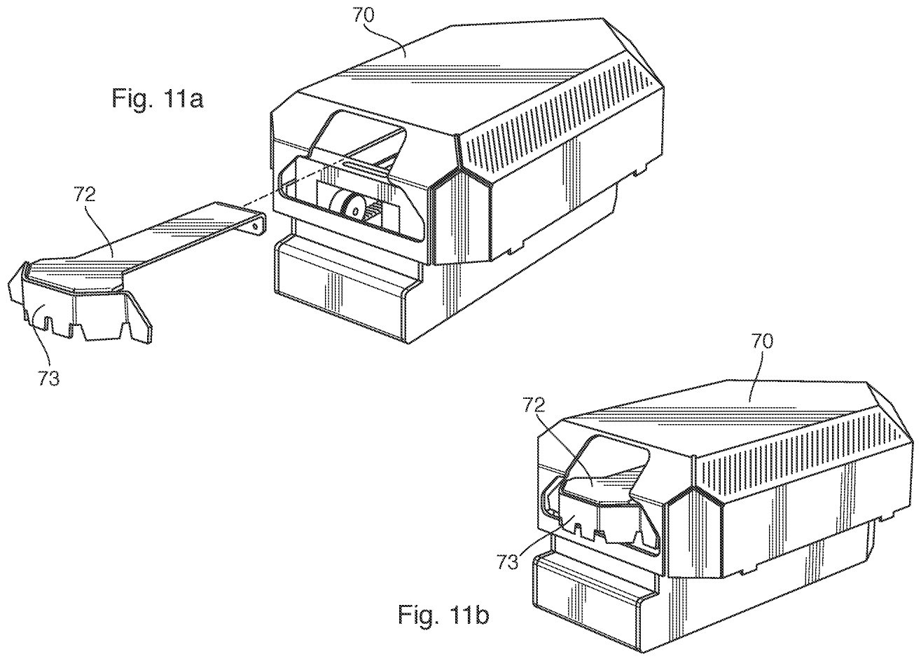

FIGS. 11a and 11b show an autonomous grill cleaner 72 of a cooking grill of an embodiment of the present invention, with a grill cleaner housing 70. The grill cleaner 72 of the autonomous cooking grill cleans the grate slats 28 (or griddle 350) after a food product is ejected from it. For the embodiment of the autonomous cooking grill with a grate 30, the grill cleaner face 73 may have grooves to scrape along the grate slates 28 towards the hub 40 and scrapes back into the grill cleaner housing 70 with any debris falling through the grate 30. The grill cleaner 72 is powered by a belt on a slide driven by an electric actuator which pushes the grill cleaner 72 and backward over the grate 30. Alternatively, the scraper can also be driven by a rack-and-pinion leadscrew or pneumatic actuator. In an embodiment of the present invention with a griddle 350, as shown in FIG. 13, the grill cleaner 72 may have a flat face 73 (not shown) to clean a griddle 350, and food debris may be pushed through an ejector opening 44 across from the grill cleaner housing 70 and through a slot in front of the grill cleaning housing 70 (not shown).

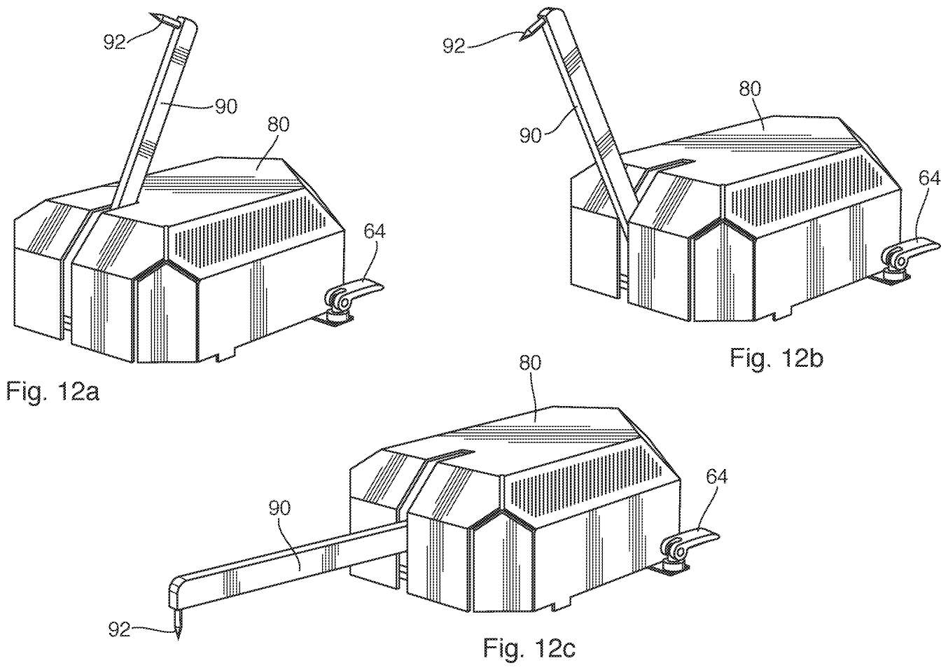

FIGS. 12a to 12c show an autonomous temperature probe arm 90 of a cooking grill 10 of an embodiment of the present invention having a thermometer 92 and with a temperature probe housing 80. FIG. 12a shows the temperature probe arm 90 in sanitizing position where the thermometer 92 and temperature probe arm 90 can be manually wiped clean with sanitizer; FIG. 12b shows the temperature probe arm 90 in home position; and FIG. 12c shows the temperature probe arm 90 in a probing position. In this embodiment, the temperature feature is activated for food products requiring certain temperatures to be reached for safety (thus, not veggie patties), but may also be used for quality control to ensure desired temperatures are reached. When activated to obtain a temperature reading when food product is present, the temperature probe arm 90 pivots on an axle driven by a belt and electric actuator which lowers the thermometer 92 into the food for a specific amount of time and then retracts the temperature probe arm 90 to a home position. The motor spins in one direction to move the temperature probe arm 90 downwards and spins in the opposite direction to move the temperature probe arm 90 upwards. The temperature probe arm 90 and thermometer 92 require sanitizing after multiple uses in accordance with safety protocols. This can be programmed to occur automatically after a certain time period or the temperature probe maintenance button 264 may be pushed manually. When sanitizing position is activated, the temperature probe goes back into sanitizing position The temperature probe arm 90 and thermometer 92 can be sanitized manually, typically with a food grade sanitizing wipe. It will be understood that a sanitizing position is not required but is helpful to avoid sanitizing preparation from dripping onto the grate 30. It will be understood that sanitizing could be automated as well.

It will be understood that the housings described above aid in protecting the mechanisms for the flippers 62, temperature probe arm 90 and grill cleaner 72, but are not required.

The autonomous cooking grill 10 can grill any food, however, the autonomous features of the cooking grill shown in the figures work with suitable food products that are capable of being flipped by the flippers 62 and ejected by the ejector. Examples of such suitable food products are, burgers (meat and veggie), steaks, fish, chickens, sausages, samosas, Jamaican patties, bagels, ham slices, dumplings, waffles, breakfast sandwiches and other foods preferably with a consistency and/or shape that does not fall through the grate or fall apart when flipped. When using a griddle 350, there may be more food options.

It will be understood that the autonomous cooking grill can be used to grill any foods without activating the features which provide autonomous flipping and/or ejecting and/or temperature measurement. The autonomous grill cleaner 72 can also not be activated if desired.

When the autonomous cooking grill 10 is loaded with a suitable food product, an autonomous flipper 62 flips the food product, and an autonomous ejector system ejects the food product from the grate 30. The autonomous cooking grill can also comprise an autonomous grill cleaner 72 to clean a segment of the grate 30, and additionally comprise an autonomous temperature probe system to measure food product temperature. Combining all these features, an embodiment of the present invention shown in the figures provides an autonomous cooking grill which flips a food product, delivers a consistently safely cooked food product, delivers a food product with grill marks on both sides, provides quality control checks of food product temperature for safety, removes a food product when cooking is complete, and cleans the grill for the next food product.

In operation of the embodiment of the autonomous cooking grill 10 shown in the figures, and in particular FIG. 3, a user activates an ignitor (not shown) and gas is delivered to the desired amount of gas burners 320 by turning open the gas knobs 222, 224, 226, 228, 232, 234. The temperature of the grate 30 is displayed on the main user display 262, which also displays the temperature of the thermometer 92 (FIG. 12a) on the temperature probe 90, and any notifications, alarms, and any safety protocol (such as, Hazard Analysis Critical Control Point, known as “HACCP”) logging information. All this information as well as the controls can be adapted as required and information can appear in this confirmation or remotely and can be controlled by computer implemented means or touch screen or remote control rather than knobs. A control system having a computer with a processing unit may be programmed to manage the particular foods being cooked on the autonomous cooking grill and the various components of the grill.

The processing unit may be configured to turn the grate 30 or griddle 350, activate the flipper(s) 62 to flip any food, activate the temperature probe arm 90 to check the temperature, activate the grill cleaner 72, and adjust the gas flow.

Grilling is typically started once the grate 30 or griddle 350 is hot enough and an infrared sensor may be used to determine the temperature of the grate/griddle. An actuator (not shown) is electrically turned on by pushing one of the selection buttons 266, 268, 272, 274, 276 and the autonomous cooking grill can be left plugged in (cord and plug not shown). Alternatively, placement of patties or food on the grate or griddle may be sensed with visual or load sensors to automatically start the grate/griddle turning. The actuator turns the axle 42 which is connected to the bottom of the hub attachment means 43, which hub attachment means 43 is attached at its top to the hub 40. Since the hub is above the ejector plate 282, an ejector plate opening 283 allows the axle to connect to the bottom of the hub attachment means 43. The turning of the hub 40 above the ejector plate 282 causes the grate 30 to rotate counterclockwise.

The autonomous cooking grill 10 can be programmed so that the grate 30 stops twelve times in a rotation. In another embodiment the autonomous cooking grill has fourteen slots rather than twelve. Alternate programming sets stops only at stations (e.g. flipping, temperature and cleaning) depending on the type and/or amount of food product on the grill. The selection buttons can be set for cooking various food products, for example, the settings can be for grilling various patties, such as a large beef patty, regular beef patty, veggie patty, junior beef patty and slider (small beef) patty, respectively. In this embodiment the selection button lights up to indicate what selection is active to confirm the selected setting. To cook a different patty, a corresponding selection button is pressed to activate a cooking protocol for that next new patty. As such, a large beef patty could have one selection and the next selection could be for a veggie patty etc.

The autonomous cooking grill stops at positions as the grate 30 or griddle 350 rotates. Using the individual grates segments 35 as positions, the grate may stop at each turn to move to the next grate segment's position, or only at specific positions e.g. when requiring either the flipping, cleaning, temperature probe, and/or ejecting activities. In an embodiment of the invention, the grill cleaner housing 70 is the twelfth position, and moving counterclockwise the next position is the first position which is where each patty is first placed/loaded on the grate 30 or griddle 350. Sensors (e.g. weight or camera/visual) can be used to detect that a patty is presently loaded on the grate 30 or griddle to automatically start the rotation and to automatically activate the appropriate actions (flipping, temperature probing, ejecting and cleaning).

If a veggie patty selection button is chosen, when the veggie patty reaches the first flipper housing the flipper 62 flips the patty during that stop, and the veggie patty moves onwards. When the veggie patty has rotated around on the grate 30 enough times to be cooked, the first ejector is activated when the patty is next to that stop and the ejector face 100 pushes the patty onto the first ejector ramp 120 and into the first bin 140. If there is another veggie patty on the grill, it will go through the same stops and processes. The activation of an ejector also activates the grill cleaner 72 to emerge from the grill cleaner housing 70 and scrape the grill for the next patty or food product.

If a regular beef patty selection button is chosen, when the regular beef patty reaches the second flipper housing 50, the flipper 62 flips the patty during that stop, then the patty moves onwards. In the embodiment in which there is a temperature probe, at the temperature probe housing 80 the grate 30 stops and the temperature probe is activated to probing position in which the thermometer is inserted in the patty and then moves back to idle position. All temperatures of patties or food on the grate/griddle can be logged per HACCP logging protocols. When the burger has rotated around on the grate 30 enough times to be cooked, the second ejector is activated so that the second ejector face 110 pushes the patty onto the second ejector ramp 130 and into the second bin 150. In accordance with HACCP principals, the temperature probe maintenance button 264 lights up and auditory alarm sounds to indicate that the thermometer 92 needs to be manually sanitized. It will be understood that in other alternative embodiments the grate/griddle could turn clockwise, there could be more or less stops, the grate could be larger or smaller, there could be only one flipper and one ejector or multiple flippers and ejectors, there could be various speeds of rotation, or one gas knob or an on/off switch to control all burners. Further, the grate or griddle could turn counterclockwise and clockwise and with the logic of artificial intelligence could take the optimal path e.g. if the food has reached optimal cooking and is farther from an ejector if it continues to travel in the direction it is moving, the direction could change to reach ejection faster.

Using different ejectors and ramps and bins avoids possible cross contamination and addressed some consumer preferences for their food product not to come into contact with another food product.

The patties or other food product remain warm in the bins 140, 150 given the vicinity to the heat from the grill. Further, the bins can be made of insulated material to assist in keeping the cooked food warm.

It will be understood that the autonomous cooking grill may be programmed as is advantageous for the particular use and user. Visual and load sensors may be customized to the desired use for the autonomous cooking grill, to sense such actions as whether there is a meat or veggie burger present, when to flip, take temperature, eject, clean etc.

If two different patties are being cooked, for example a regular meat patty and then a veggie patty, the selection button for a meat patty is chosen and it is placed at position 1, and, when the meat patty is at position 2, the selection button for a veggie patty is selected and the veggie patty is place at position 1. The meat patty will be flipped at the second housing 50 whereas the veggie patty will be flipped at first housing 60, each time that the grate 30 makes a rotation. A flipper 62 is only activated to flip the correct patty based on the selection button since the selection button indicates that the patty will be at that spot in six stops for a meat patty and three stops for a veggie patty. The flippers 62 don't flip based on the presence of a burger when the selection button is chosen. In an alternative embodiment the flipper flips based on the presence of a patty sensed with a load cell and/or vision system.

The time for which a food product rotates on the grate 30 is based on the selection chosen, which can be activated by a button as shown, or by a remote control or App or computer program etc. For example, in one setting a junior beef patty rotates twice at 45 seconds each rotation for a total of 90 seconds; a regular beef patty and a veggie patty each do four rotations for a total cook time of about 180 seconds. A larger beef patty may need six rotations for a total of 270 seconds. It will be understood that a larger grate 30 would cook patties in less rotations and increasing or decreasing the heat will also increase or decrease the speed of cooking.

In an alternative embodiment a load cell and visual sensor detects the type of food product and automatically selects the number of rotations, where the food product will be flipped, and when ejected, rather than pressing a selection button.

In an embodiment of the invention, as food products are added to the bins, the respective first and second ejector counters 242, 244 keep track with visual or weight sensors, and when at capacity, for example, ten patties, an auditory alarm warning indicates that the bin needs to be emptied. The bin 140 or bin 150 is then emptied and the respective ejector reset button 246, 248 is pushed to reset. If either bin is removed, the grate 30 stops turning, so the ejectors don't push a food product off without a bin present to catch it. Replacing a bin re-starts the grate turning.

Drippings, food debris, grease etc. fall through the grate 30 (or the ejector opening 44 and holes in the griddle 350) and are caught by first drip tray 284 and second drip tray 286. To clean the first drip tray 284, the first drip tray handle 200 is pulled and the first drip tray 284 slides out through the first drip tray slot 205. To clean the second drip tray 286, the second drip tray handle 210 is pulled and the second drip tray 286 slides out through the second drip tray slot 215.

The housings, namely the first flipper housing 60, second flipper housing 50, grill cleaner housing and temperature probe housing 80 are not required, but keep the grill cleaner 72, flippers 62, their inner workings, and the temperature probe inner workings cleaner. The respective housings 50, 60, 70, 80 can be secured with quick release handles 64 so that when cleaning is required, they can be easily removed and reattached, or can have other means of securing to the grill or not be used at all or be configured as one contiguous housing for the flippers 62, grill cleaner 72 and temperature probe 90.

The grill of the present invention can be constructed of materials for traditional grills or new materials as developed. For example, the grill body can be stainless streel, and more particularly can be 10-gauge 304 stainless steel. The burners can be natural gas burners that are propane compatible. There can be twelve individual burners for each grill slot in six pairs. Safety measures can be included, for example, if gas knobs are on without flame, the gas valve will automatically shut off. Also, in the absence of electricity, a gas valve will be turned off automatically (although there may be an option to manually turn on). The grate 30 can be high-quality cast-iron or suitable plastic and each portion of the grill on which a burger is placed may have parallel lines so all grill marks on patties will be parallel or whatever aesthetically pleasing grill marking is desired. The frame 29 for the grate 30 can be steel.

The flippers 62, grill cleaner 72, ejector faces 100, 110, bins 140, 150 and housings, may all be easily removable for frequent washing. The grate segments 35 are also easily removable for washing but require it less frequently.

In an electric alternative of the present invention, the gas burners, gas knobs, gas piping etc. are not present. In a further alternative, debris and drippings can be caught through holes in the griddle 350, for example, one per each section that holds a food product, and as such can be configured not to require the large drip trays 284, 286.

In the embodiment of the invention shown in the figures, there are two flippers 62, two ejectors 99, one temperature probe 90 and one grill cleaner 72, however, it will be understood that the grill can be scaled up or down and have single or multiple flippers etc. This embodiment may have a grate 30 or griddle 350. It is to be understood that this invention is not limited to particular variations since various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

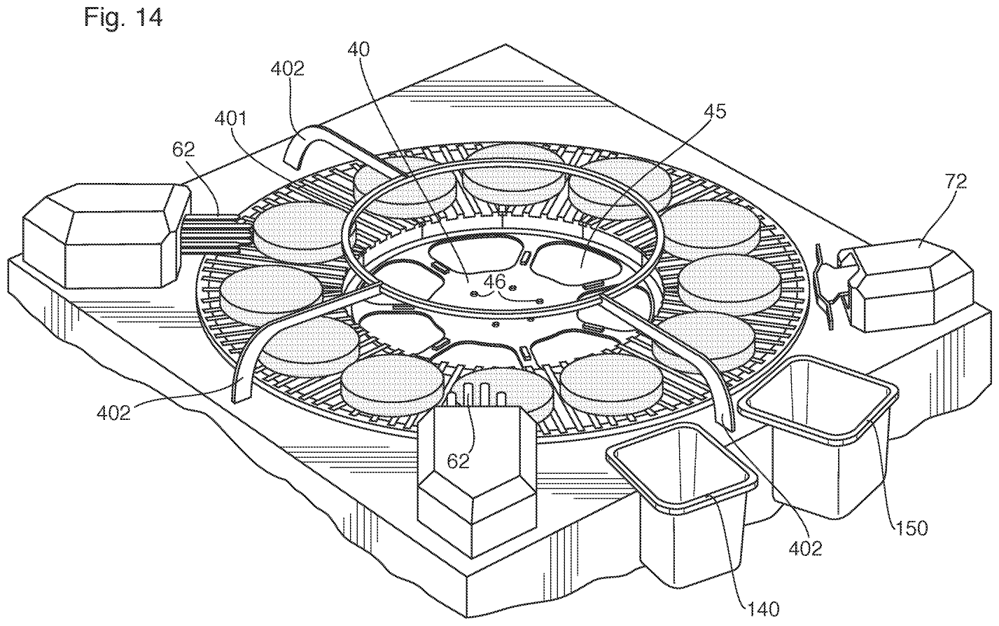

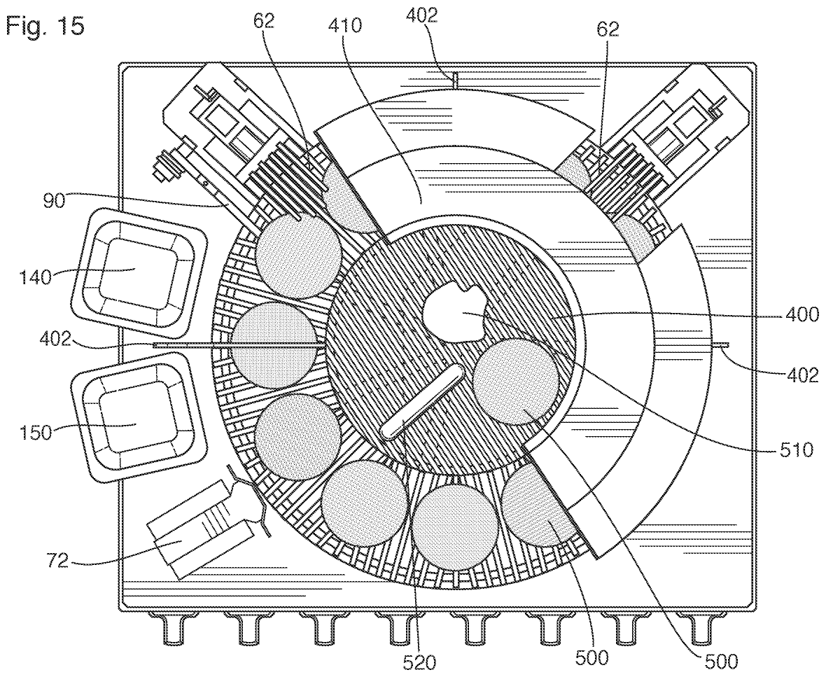

The autonomous cooking grill 10 shown in FIGS. 14 and 15 additionally comprises a non-rotatable center grill 400, shown in FIG. 15, which may be a grate or griddle for manually cooking food, such as a burger 500, chicken 510 and/or wiener 520. FIG. 14 shows a hub 40 with hub openings 45 which allow heat to rise up through from additional gas burner(s) (not shown), for example, four central gas burners or one big gas burner. The autonomous cooking grill with a center grill 400 does not comprise ejectors 99 and as such the hub 40 is lower than the hub 40 shown in FIGS. 1 to 6. The center grill 400 or the whole autonomous cooking grill 10 of this embodiment may alternatively be heated with electric power. The center grill 400 rests on a grill ring 401, which grill ring 401 is held above the hub 40 by ring supports 402. It will be understood that the center grill could be rotatable, for example, if it was instead connected to the hub by a central support (not shown)

FIG. 15 has some modifications from the autonomous cooking grill of FIG. 14 namely the addition of a cover 410 and the removal of housings for the flippers 62. The autonomous cooking grill 10 shown in FIGS. 1 to 6 may also comprise such a cover 410. The cover 410 partially covers a grill 30 or griddle 350 and decreases cooking time since it traps heat, and it also prevents grease from splattering. It may be removable and can be comprised of sheet metal. In FIG. 15 a temperature probe 90 is located beside a flipper 62.

In a further embodiment of the invention, the autonomous cooking grill 10 comprising a grate 30 or griddle 350 connected to a rotatable hub which is connected to a hub rotating means, all supported by a grill body, wherein when the hub rotating means is activated the hub rotates the grate, additionally comprises a robot or a robot arm capable of performing one or more of the functions of food flipping, food ejecting, food removing, food temperature measuring and grate or griddle cleaning. In this embodiment with a robot arm, the robot arm may be situated beside, above or as part of the autonomous cooking grill 10. These robot arms are available from third parties and provide four degrees of freedom or up to seven axes. Where regulations require it, these industrial robotic arms are available in food-grade or covered with a sleeve or similar material to ensure compliance with such regulations, including a sleeve that is pressurized with clean, dry air to limit contamination.

In a further embodiment of the invention, the autonomous cooking grill 10 comprises a grate 30 or griddle 350 connected to a rotatable hub which is connected to a hub rotating means, all supported by a grill body, and comprises one or more flippers 62, and comprises a robot arm capable of performing one or more of the functions of food ejecting, food removing, food temperature measuring and grate or griddle cleaning. Alternatively, this autonomous cooking grill may additionally comprise a grill cleaner 72 and/or temperature probe 90, and the robot arm performs at least the functions of food ejecting or food removing.

If there is no power to rotate the autonomous cooking grill 10, it may be used to cook on manually just like a regular grate or griddle, provided that the gas is still working.

While embodiments of the invention have been described in the detailed description, the scope of the claims should not be limited by the preferred embodiments set forth in the examples, but should be given the broadest interpretation consistent with the description as a whole.

1. An autonomous cooking grill comprising a grate connected to a rotatable hub which is connected to a hub rotating means, all supported by a grill body, wherein when the hub rotating means is activated the hub rotates the grate.

2. The autonomous cooking grill of claim 1, additionally comprising at least one autonomous flipper.

3. The autonomous cooking grill of claim 2, additionally comprising at least one autonomous ejector.

4. The autonomous cooking grill of claim 1, additionally comprising at least one autonomous flipper, at least one autonomous ejector, and at least one autonomous grate cleaner.

5. The autonomous cooking grill of claim 1, additionally comprising at least one autonomous flipper and at least one autonomous grate cleaner.

6. The autonomous cooking grill of claim 2, additionally comprising an autonomous temperature probe.

7. The autonomous cooking grill of claim 3, additionally comprising an autonomous temperature probe.

8. The autonomous cooking grill of claim 4, additionally comprising an autonomous temperature probe.

9. The autonomous cooking grill of claim 5, additionally comprising an autonomous temperature probe.

10. The autonomous cooking grill of claim 2, in which the at least one autonomous flipper is two autonomous flippers.

11. The autonomous cooking grill of claim 3, in which the at least one autonomous ejector is two autonomous ejectors.

12. The autonomous cooking grill of claim 3, in which the at least one autonomous flipper is two autonomous flippers and the at least one autonomous ejector is two autonomous ejectors.

13. The autonomous cooking grill of claim 1, additionally comprising at least one gas burner to heat the grate and additionally comprising a bin capable of holding food.

14. The autonomous cooking grill of claim 1, in which the hub rotating means is comprised of a hub attachment means with a top side and bottom side, an axle with a first end and a second end, and an actuator connecting means with a first end and a second end, which hub attachment means is attached on its top side to an underside of the hub and is attached on its bottom side to the first end of the axle, which second end of the axle is attached to the first end of the actuator connecting means, and the second end of the actuator connecting means is connected to an actuator.

15. The autonomous cooking grill of claim 1, which additionally comprises a supporting frame and wherein the supporting frame is attached to the hub and the grate rests on the supporting frame.

16. The autonomous cooking grill of claim 1, in which the grate comprises grate segments.

17. The autonomous cooking grill of claim 1, additionally comprising a robot or robot arm capable of performing one or more of the functions of food flipping, food ejecting, food removing, food temperature measuring, and grate cleaning.

18. An autonomous cooking grill comprising a griddle connected to a rotatable hub which is connected to a hub rotating means, all supported by a grill body, wherein when the hub rotating means is activated the hub rotates the griddle.

19. The autonomous cooking grill of claim 18, additionally comprising at least one autonomous flipper and at least one autonomous grate cleaner.

20. The autonomous cooking grill of claim 18, additionally comprising at least one autonomous flipper, at least one autonomous ejector, and at least one autonomous grate cleaner.

21. The autonomous cooking grill of claim 19, additionally comprising an autonomous temperature probe.

22. The autonomous cooking grill of claim 18, additionally comprising a robot or robot arm capable of performing one or more of the functions of food flipping, food ejecting, food removing, food temperature measuring, and griddle cleaning.

23. An autonomous cooking grill comprising a rotatable grate or griddle connected to a rotating means, comprising at least one autonomous tool.

24. The autonomous cooking grill of claim 23, wherein the at least one autonomous tool is a flipper.

25. An autonomous cooking grill of claim 23, in which the at least one autonomous tool are a flipper and an ejector.

26. An autonomous cooking grill of claim 23, in which the at least one autonomous tool are a flipper and a grill cleaner.

27. An autonomous cooking grill of claim 23, in which the at least one autonomous tool are a flipper and an ejector and a grill cleaner and a temperature probe.

28. The autonomous cooking grill of claim 23, wherein the at least one autonomous tool is one tool capable of flipping, ejecting, and cleaning.

29. The autonomous cooking grill of claim 23, wherein the at least one autonomous tool is one tool capable of flipping, temperature probing, ejecting, and cleaning.

30. The autonomous cooking grill of claim 23, wherein the at least one autonomous tool is one tool capable of flipping and ejecting.

31. The autonomous cooking grill of claim 23, wherein the at least one autonomous tool are a first tool capable of flipping and ejecting and a second tool capable of cleaning.

32. The autonomous cooking grill of claim 23, wherein the at least one autonomous tool are a first tool capable of flipping and a second tool capable of ejecting and cleaning.

33. The autonomous cooking grill of claim 23, additionally comprising a processing unit configured to control the at least one autonomous tool.

34. The autonomous cooking grill of claim 23, additionally comprising a partial cover for covering part of the grate or griddle.

35. The autonomous cooking grill of claim 23, additionally comprising a rotatable center grill for manually cooking food.

36. The autonomous cooking grill of claim 23, additionally comprising a non-rotatable center grill for manually cooking food.
